(19) United States
(12) Patent Application Publication
(10) Pub. No.: US 2025/0119458 A1
(43) Pub. Date: Apr. 10, 2025

(54) DEVICES AND METHODS FOR POLICY COMMUNICATION IN A WIRELESS LOCAL AREA NETWORK

(71) Applicant: HUAWEI TECHNOLOGIES CO., LTD., Shenzhen (CN)

(72) Inventors: Michael MONTEMURRO, Ottawa (CA); Stephen MCCANN, Ottawa (CA); Yuchen GUO, Shenzhen (CN)

(21) Appl. No.: 18/986,994

(22) Filed: Dec. 19, 2024

Related U.S. Application Data
(63) Continuation of application No. PCT/CN2022/099707, filed on Jun. 20, 2022.

(51) Int. Cl. H04L 9/40; H04W 84/12

(52) U.S. Cl. CPC H04L 63/20; H04W 84/12

(57) ABSTRACT

An access point, AP, (110) configured to communicate with a non-AP station (120) in a wireless local area network, WLAN (130). The AP (110) comprises a processing circuitry (111) configured to generate a nonce and a communication interface (113) configured to transmit a first message to the non-AP station (120). The first message (202) comprises the nonce. In response to receiving a second message from the non-AP station (120), the processing circuitry (111) is further configured to encrypt information about one or more policies. The information about the one or more policies identifies one or more policies to be applied by the non-AP station (120). The communication interface (113) is further configured to transmit a third message to the non-AP station (120). The third message comprises the encrypted information about the one or more policies.

### CROSS-REFERENCE TO RELATED APPLICATIONS

This application is a continuation of International Application No. PCT/CN2022/099707, filed on Jun. 20, 2022, the disclosure of which is hereby incorporated by reference in its entirety.

### TECHNICAL FIELD

The present invention relates to wireless communications. More specifically, the present invention relates to devices and methods for policy communication in a wireless local area network.

### BACKGROUND

In managed networks, a wireless local area network (WLAN) infrastructure can apply a network policy to a WLAN device, such as a non-AP station (STA) when the STA authenticates and connects to that infrastructure. The network policy can comprise features and rules such as packet filtering, traffic classification, and traffic prioritization. Generally, this network policy is associated with a user and communicated from a network policy server using Authentication, Authorization and Accounting (AAA) and IEEE 802.11 (over the air) protocols. However, in traditional association approaches the network policy is sometimes received and applied in the WLAN infrastructure without being communicated to the WLAN device. However, there are cases where the network policy needs to be communicated to the WLAN device (e.g. WLAN device-based channel access) in order to be applied when the security association is complete. In this case, the policy communication needs to be delivered securely to prevent personally identifiable (PII) information of the user being exposed.

### SUMMARY

It is an objective of the present disclosure to provide devices and methods for a more secure policy communication in a wireless local area network.

The foregoing and other objectives are achieved by the subject matter of the independent claims. Further implementation forms are apparent from the dependent claims, the description and the figures.

According to a first aspect an access point, AP, is provided which is configured to communicate with a non-AP station in a wireless local area network, WLAN, in particular an IEEE 802.11 based WLAN. The AP comprises a processing circuitry configured to generate a nonce (also referred to as an authenticator nonce or ANonce). The AP further comprises a communication interface configured to transmit a first message to the non-AP station. The first message comprises the nonce. In response to receiving a second message from the non-AP station, the processing circuitry is further configured to encrypt information about one or more policies. The information about the one or more policies identifies one or more policies to be applied by the non-AP station. The communication interface is further configured to transmit a third message to the non-AP station. The third message comprises the encrypted information about the one or more policies.

In a further possible implementation form of the first aspect, the first message is a first Extensible Authentication Protocol over Local Area Network, EAPOL, key message, the second message is a second EAPOL key message and the third message is a third EAPOL key message of a 4-way handshake between the AP and the non-AP station. The second EAPOL key message comprises a further nonce (also referred to as a supplicant nonce or SNonce).

In a further possible implementation form of the first aspect, in response to transmitting the third EAPOL key message to the non-AP station, the communication interface is further configured to receive a fourth EAPOL key message from the non-AP station.

In a further possible implementation form of the first aspect, the processing circuitry is configured to derive one or more cryptographic keys based on the nonce and/or the further nonce. In an implementation form the processing circuitry is configured to derive the one or more cryptographic keys based on the nonce and/or the further nonce as well as credential information and other parameters within the messages. The credential information may include keys associated with certificates, or passwords, which are provisioned on the device.

In a further possible implementation form of the first aspect, the second EAPOL key message may comprise a request for the information about the one or more policies by the non-AP station.

In a further possible implementation form of the first aspect, the first message is an 802.11 authentication response, the second message is an association request, and the third message is an association response of a fast transition or a fast initial link setup between the AP and the non-AP station.

In a further possible implementation form of the first aspect, the communication interface is configured to transmit the 802.11 authentication response to the non-AP station, in response to receiving an 802.11 authentication request from the non-AP station. The 802.11 authentication request comprises a further nonce (also referred to as a supplicant nonce or SNonce).

In a further possible implementation form of the first aspect, the processing circuitry is configured to derive one or more cryptographic keys based on the nonce and/or the further nonce. In an implementation form, the processing circuitry is configured to derive the one or more cryptographic keys based on the nonce and/or the further nonce as well as credential information and other parameters within the messages. The credential information may include keys associated with certificates, or passwords, which are provisioned on the device.

In a further possible implementation form of the first aspect, the association response comprises a mobility domain element, MDE. The encrypted information about the one or more policies is part of the MDE.

In a further possible implementation form of the first aspect, the 802.11 authentication request from the non-AP station comprises a request for the information about the one or more policies by the non-AP station.

In a further possible implementation form of the first aspect, the third message comprising the encrypted information about the one or more policies comprises information about the number of the one or more policies.

In a further possible implementation form of the first aspect, the third message comprising the encrypted information about the one or more policies comprises an indicator of a respective type of the one or more policies and/or information about a respective size of the one or more policies.

In a further possible implementation form of the first aspect, the communication interface is configured to receive the information about the one or more policies from a policy server.

According to a second aspect a method is provided of operating an access point, AP, configured to communicate with a non-AP station in a wireless local area network, WLAN.

The method comprises a step of generating a nonce (also referred to as authenticator nonce or ANonce).

The method further comprises a step of transmitting a first message to the non-AP station, wherein the first message comprises the nonce.

The method further comprises a step of encrypting, in response to receiving a second message from the non-AP station, information about one or more policies, wherein the information about the one or more policies identifies one or more policies to be applied by the non-AP station.

The method further comprises a step of transmitting a third message to the non-AP station, wherein the third message comprises the encrypted information about the one or more policies.

The method according to the second aspect of the present disclosure can be performed by AP according to the first aspect of the present disclosure. Thus, further features of the method, according to the second aspect of the present disclosure, result directly from the functionality of the AP according to the first aspect of the present disclosure as well as its different implementation forms described above and below.

According to a third aspect a computer program product is provided, comprising program code which causes a computer or a processor to perform the method according to the second aspect, when the program code is executed by the computer or the processor.

According to a fourth aspect the invention provides a method for exchanging policy information between an access point, AP, and a non-AP station in a wireless local area network, WLAN, wherein the method comprises the AP and the non-AP station exchanging authentication messages, and deriving a key from the authentication messages. The method further comprises the AP transmitting to the non-AP station a policy information request. Also, the method further comprises the AP receiving from the non-AP station a policy information response.

In a further possible implementation form of the fourth aspect the policy information request is a modified EPCS Priority Access Enable Request frame.

In a further possible implementation form of the fourth aspect the modified EPCS Priority Access Enable Request comprises a Policy Multi-Link Element replacing a Priority Access Multi-Link element.

In a further possible implementation form of the fourth aspect the policy information response is a modified EPCS Priority Access Enable Response frame.

In a further possible implementation form of the fourth aspect the modified EPCS Priority Access Enable Response frame comprises a Policy Multi-Link Element replacing a Priority Access Multi-Link element.

According to a fifth aspect the invention provides a method for exchanging policy information between an access point, AP, and a non-AP station in a wireless local area network, WLAN, wherein the method comprises the AP and the non-AP station exchanging authentication messages, and deriving a key from the authentication messages. The method further comprises the non-AP station transmitting to the AP a policy information request. Also, the method further comprises the non-AP station receiving from the AP a policy information response.

In a further possible implementation form of the fifth aspect the policy information request is a modified EPCS Priority Access Enable Request frame.

In a further possible implementation form of the fifth aspect the modified EPCS Priority Access Enable Request comprises a Policy Multi-Link Element replacing a Priority Access Multi-Link element.

In a further possible implementation form of the fifth aspect the policy information response is a modified EPCS Priority Access Enable Response frame.

In a further possible implementation form of the fifth aspect the modified EPCS Priority Access Enable Response frame comprises a Policy Multi-Link Element replacing a Priority Access Multi-Link element.

According to a sixth aspect the invention provides an access point, AP, configured to communicate with a non-AP station in a wireless local area network, WLAN, wherein the AP comprises a communication interface configured to exchange authentication messages with the non-AP station, and derive a key from the authentication messages. The communication interface is further configured to transmit to the non-AP station a policy information request. Also, the communication interface is further configured to receive from the non-AP station a policy information response.

In a further possible implementation form of the sixth aspect the policy information request is a modified EPCS Priority Access Enable Request frame.

In a further possible implementation form of the sixth aspect the modified EPCS Priority Access Enable Request comprises a Policy Multi-Link Element replacing a Priority Access Multi-Link element.

In a further possible implementation form of the sixth aspect the policy information response is a modified EPCS Priority Access Enable Response frame.

In a further possible implementation form of the sixth aspect the modified EPCS Priority Access Enable Response frame comprises a Policy Multi-Link Element replacing a Priority Access Multi-Link element.

According to a seventh aspect the invention provides a non-AP station, configured to communicate with an AP in a wireless local area network, WLAN, wherein the non-AP station comprises a communication interface configured to exchange authentication messages with the AP, and derive a key from the authentication messages. The communication interface is further configured to transmit to the AP station a policy information request. Also, the communication interface is further configured to receive from the AP a policy information response.

In a further possible implementation form of the seventh aspect the policy information request is a modified EPCS Priority Access Enable Request frame.

In a further possible implementation form of the seventh aspect the modified EPCS Priority Access Enable Request comprises a Policy Multi-Link Element replacing a Priority Access Multi-Link element.

In a further possible implementation form of the seventh aspect the policy information response is a modified EPCS Priority Access Enable Response frame.

In a further possible implementation form of the seventh aspect the modified EPCS Priority Access Enable Response frame comprises a Policy Multi-Link Element replacing a Priority Access Multi-Link element.

According to an eighth aspect the invention provides a data structure for a computer implementation of any of the methods of the fourth and fifth aspects, where in the data structure comprises a policy information request comprising a Category field, a Protected EHT Action field, a Dialog Token field, and a Policy Multi-Link Element field.

According to a ninth aspect the invention provides a data structure for a computer implementation of any of the sixth and seventh aspects, where in the data structure comprises a policy information response comprising a Category field, a Protected EHT Action field, a Dialog Token field, a Status Code field, and a Policy Multi-Link Element field.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows an exemplary wireless local area network;

FIG. 2a shows a signaling diagram between an AP according to an embodiment and a non-AP station using a 4-way handshake;

FIG. 2b shows a signaling diagram between an AP according to an embodiment and a non-AP station using a request/response based 4-way handshake;

FIG. 3a shows a signaling diagram between an AP according to an embodiment and a non-AP station using a fast transition message exchange;

FIG. 3b shows a signaling diagram between an AP according to an embodiment and a non-AP station using a request/response based fast transition message exchange;

FIG. 3c shows a signaling diagram between an AP according to an embodiment and a non-AP station using a fast initial link setup message exchange;

FIG. 3d shows c station using a request/response based fast initial link setup message exchange;

FIGS. 4a-d show data structures of a policy key data encapsulation generated by an AP according to an embodiment; and

FIG. 5 shows a flow diagram illustrating steps of a method of operating an AP according to an embodiment in a WLAN.

FIGS. 6a-b show data structures illustrating respectively the state of the art EPCS Priority Access Enable Request frame (IEEE 802.11 Draft 1.4) and the modified EPCS Priority Access Enable Request frame of the present invention.

FIGS. 6c-d show data structures illustrating respectively the state of the art EPCS Priority Access Enable Response frame (IEEE 802.11 Draft 1.4) and the modified EPCS Priority Access Enable Response frame of the present invention.

FIG. 7 shows a signaling diagram between an AP according to an embodiment and a non-AP station for the exchange of policy information.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

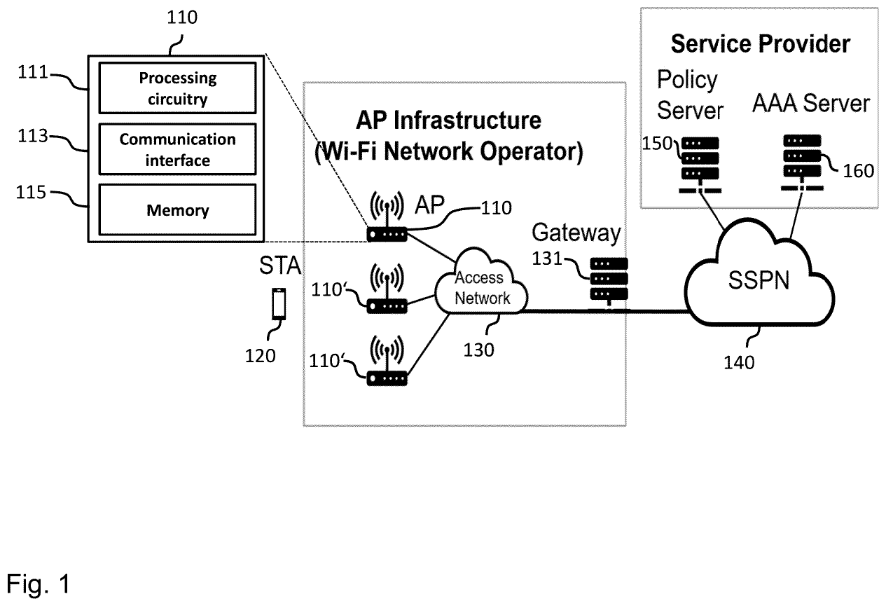

FIG. 1 shows an exemplary wireless local area network 130, WLAN 130, comprising an access point 110, AP 110, configured to communicate with a non-AP station 120. The non-AP station 120, may be for example a smartphone 120. The WLAN 130 may comprise a plurality of further APs or non-AP stations 110′. The WLAN 130 may be connected via a Gateway 131 to a Subscription Service Provider Network 140, SSPN 140. The SSPN 140 may comprise a policy server 150 and an authentication, authorization and accounting, AAA, server 160. Alternatively, the WLAN 130 may comprise the policy server 150 and/or the AAA server 160.

As illustrated in FIG. 1, the AP 110 comprises a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analogue and digital circuitry. Digital circuitry may comprise components such as application-specific integrated circuits (ASICs), field-programmable arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

Before describing different embodiments of the AP 110 in more detail, in the following some technical background as well as terminology will be introduced making use of one or more of the following abbreviations:
AAA Authentication, Authorization and Accounting
AP Access Point
BSS Basic Service Set
CID Company Identifier
DIAMETER an authentication, authorization, and accounting protocol for computer networks
EDCA Enhanced Distributed Channel Access
EHT Extremely High Throughput
EPCS Emergency Preparedness Communications service
FILS Fast Initial Link Setup
FT Fast Transition
KDE Key Data Encapsulation
LDAP Lightweight Directory Access Protocol
MLD Multi-Link Device
MLO Multi-Link Operation
OUI Organizationally Unique Identifier
PII Personally Identifiable Information
PTK Pairwise Transient Key
QOS Quality of Service
RADIUS Remote Authentication Dial-In User Service
RSNA Robust Security Network Association
STA Station
SSPN Subscription Service Provider Network
TID Traffic Identifier

For example, in traditional approaches, when the non-AP station 120 associates with the AP 110 in the WLAN 130, the communication interface 113 of the AP 110 may communicate with the AAA server 160 via authentication protocols such as RADIUS or DIAMETER. The AAA server 160 and the non-AP station 120 may perform mutual authentication. Upon successful authentication, the AAA server 160 may retrieve a policy for the non-AP station 120 from the policy server 150 via a protocol such as LDAP and passes the result of the authentication along with the policy back to the communication interface 113 of the AP 110. When authentication is successful, the non-AP station 120 may establish network connectivity and the communication interface 113 of the AP 110 may apply the network policy for the STA 120. The network policy may comprise features such as packet filtering, traffic classification, and traffic prioritization.

Within IEEE 802.11, information that is transmitted between two peer STAs that may assist in determining information about the identity of a device user is regarded as personally identifiable information, PII. A recognized method to reduce the leaking of PII within an IEEE 802.11 message is to encrypt messages between the non-AP station 120 and the AP 110 and minimize the information exchanged during the establishment of network access.

An EDCA Parameter Set is defined as a set of IEEE 802.11 channel access parameters to allow traffic prioritization. The AP 110 may advertise the EDCA Parameters Set to be used for communications in the BSS (i.e. non-AP stations 120 together with their associated AP 110) using Beacons and Probe Responses. These advertisements are broadcast to all non-AP stations 120 from the AP 110 in the clear, e.g. are not encrypted.

Additionally, IEEE 802.11be is also defining that a feature called Multi-Link Operation (MLO) allows two MLDs (AP MLD and non-AP MLD) to communicate over multiple, independent radio connections or links. One feature of MLO is called TID-to-Link Mapping. TID-to-Link mapping allows two MLDs to negotiate which traffic types are communicated over which link, between them. TID-to-Link mapping can be negotiated either (i) during the association request and response messages or (ii) through action frames once a device has been successfully associated. However, within option (i), the TID-to-Link mapping information is transmitted in the clear, compromising the security of the information, and in option (ii), the action frames, although with an encrypted payload, allow the source address and the destination address to be tracked, leaking PII.

In managed networks, the AP infrastructure receives a network policy from the AAA infrastructure when a STA successfully associates with the network. The network policy is applied at the AP and is not communicated to the STA.

Unlike packet filtering and traffic prioritization policy, which are applied at the AP 110, other policies such as TID-to-Link mapping or uplink EDCA channel access parameters need to be communicated to the non-AP station 120. The other policies such as TID-to-Link mapping are negotiated in the exchange of 802.11 association request/response frame, or through a management frame exchange after successful association.

The problem is that STA specific policies are not transmitted from the AP 110 during the IEEE 802.11 Association/4-way handshake exchanges in a secure fashion. They are either transmitted within these exchanges in the clear (e.g. not encrypted) or transmitted following the completion of these exchanges in a separate frame exchange.

If authentication with the STA is performed using authentication protocols such as Extensible Authentication Protocol (EAP) that required an AAA server, the AP infrastructure may need to assign a policy for the STA after the Association Request/Response frames are exchanged and association has completed.

Correspondingly, there is no mechanism for a non-AP station 120 to request a policy from the policy server 150, via the AP 110 and AAA server 160, and to receive the response in a secure manner during the IEEE 802.11 Association/4-way handshake exchanges.

For example, EDCA channel access parameters are broadcast to the BSS (i.e. in Beacons and Probe Responses) and TID-to-Link mapping policy is either communicated (i) within the IEEE 802.11 Association/4-way handshake exchanges in the clear or (ii) in a separate frame exchange after the IEEE 802.11 Association/4-way handshake exchanges have completed. An additional problem is that PII is leaked in these examples. Either the policy data is transmitted in the clear, or within an encrypted payload of a protected frames (e.g. the TID-to-Link mapping post association exchange), which still exposes the source address and destination address of the protected frame exchange.

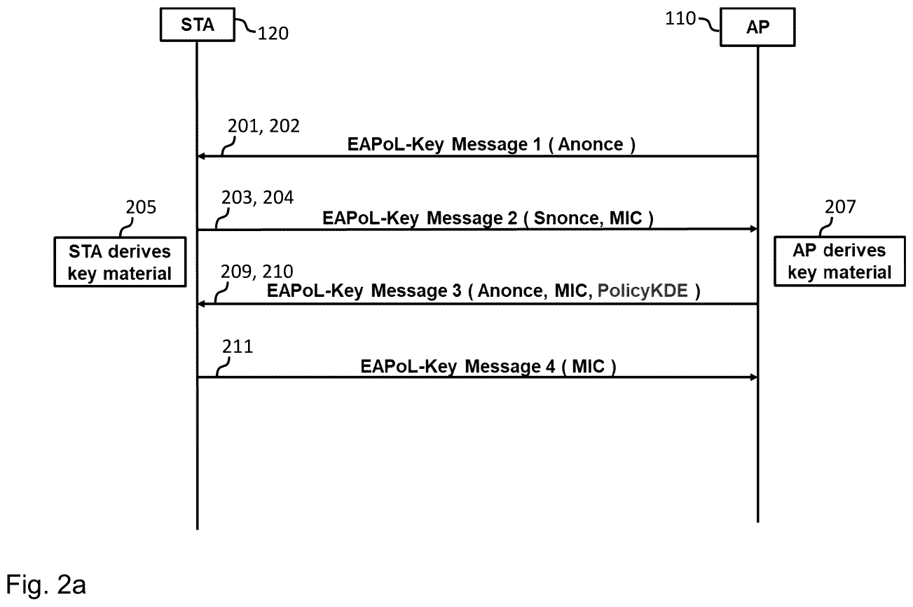

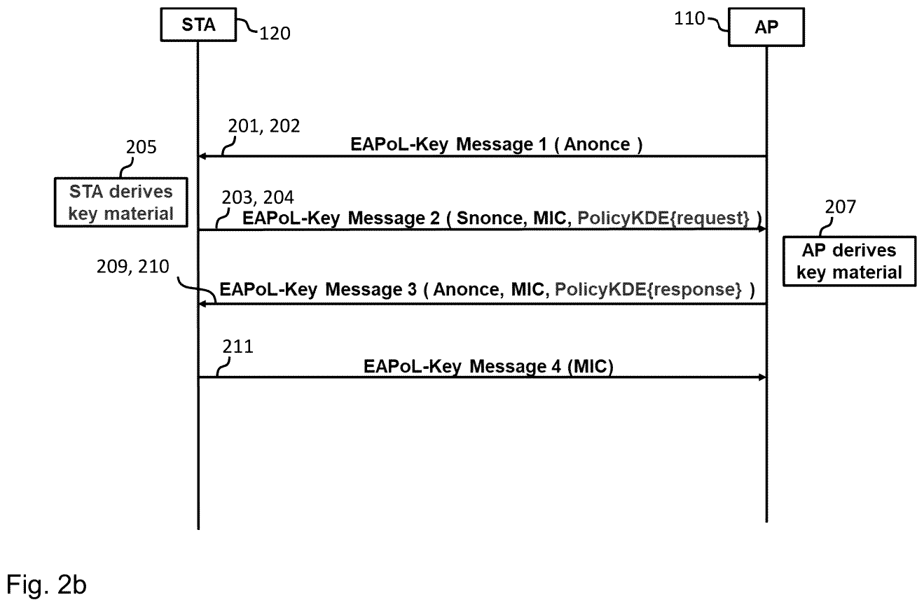

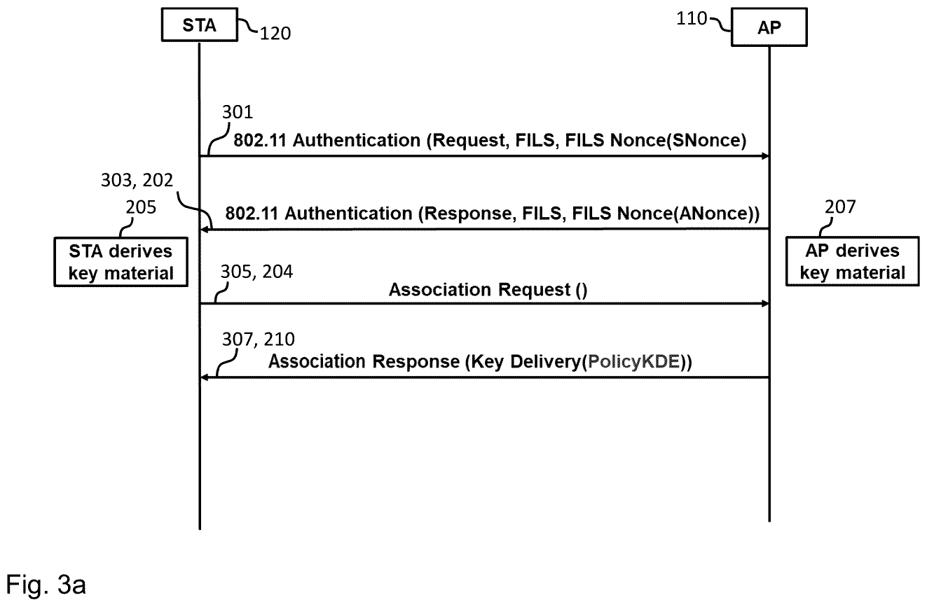

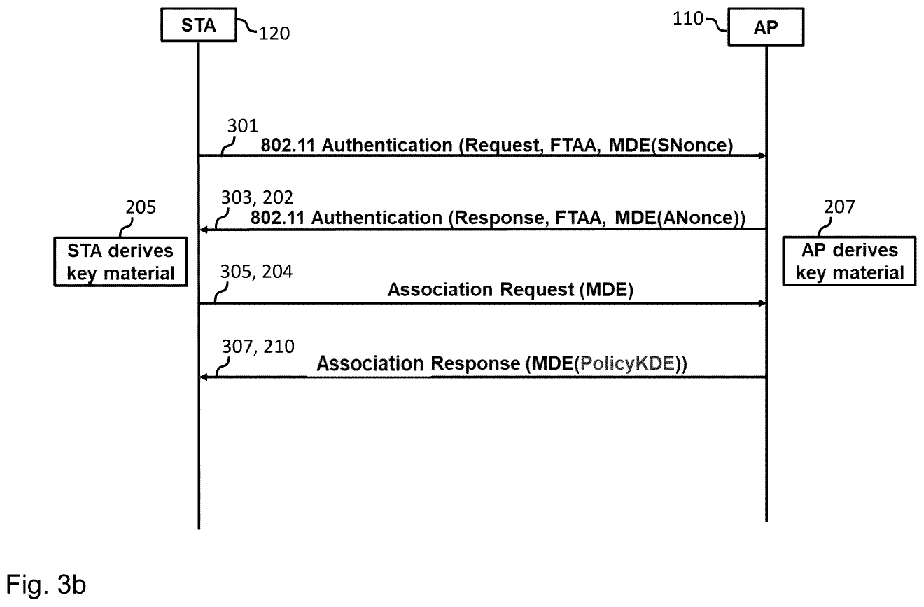

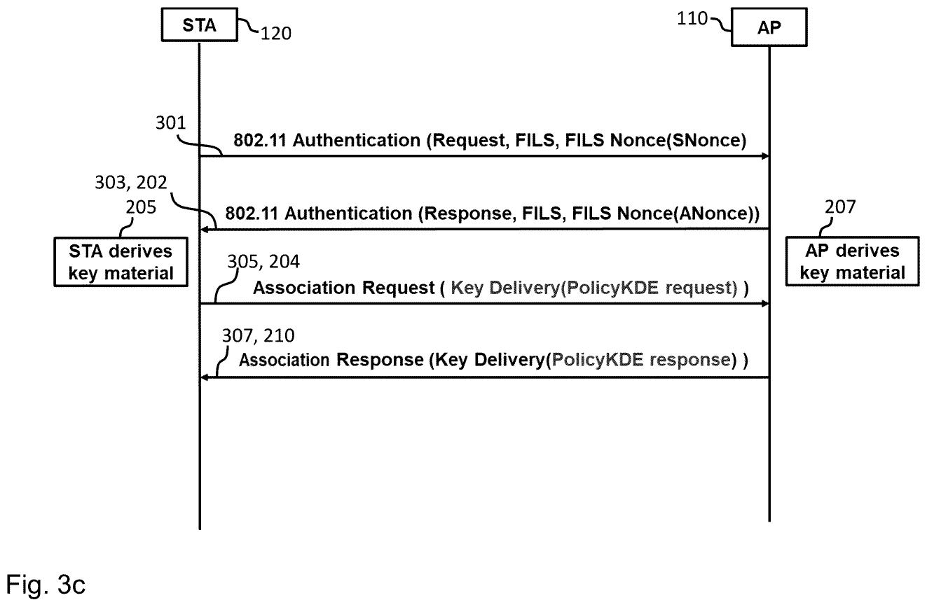

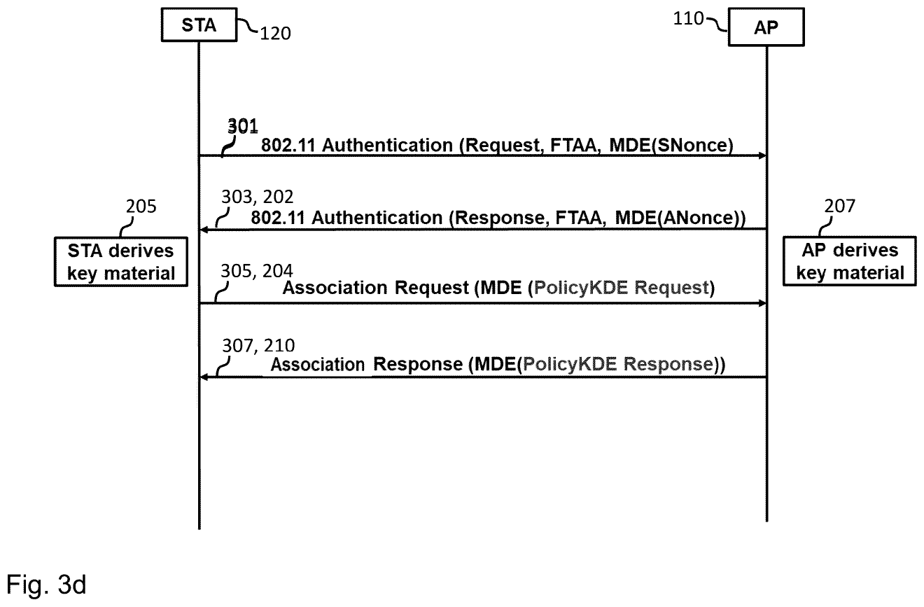

FIG. 2a shows a flow diagram illustrating steps implemented by the processing circuitry 111 of the AP 110 according to an embodiment using a 4-way handshake for a Robust Security Network Association, RSNA. As will be appreciated, only a few selected parameters of the messages are shown in FIG. 2a and in the following FIGS. 2b to 3d.

In step 201 of FIG. 2a, the processing circuitry 111 of the AP 110 is configured to generate an authenticator nonce (also referenced to as ANonce). The communication interface 113 of the AP 110 transmits a first message 202 to the non-AP station 120 (or for short “STA 120”). The first message 202 comprises the nonce, and other parameters that are not shown. As illustrated in FIG. 2a, the first message 202 may be a first Extensible Authentication Protocol over Local Area Network, EAPOL, key message of a 4-way handshake between the AP 110 and the non-AP station 120.

In step 203 of FIG. 2a, the communication interface 113 may receive a second message 204 from the non-AP station 120. The second message 204 may be a second EAPOL key message of a 4-way handshake between the AP 110 and the non-AP station 120. The second EAPOL key message may comprise a supplicant nonce (also referenced to as a SNonce).

In step 205 of FIG. 2a, the non-AP station 120 may derive a pairwise transient key (PTK) based on the Anonce and the Snonce, together with stored credential information and other parameters within the messages, in response to transmitting the second message 204.

In step 207 of FIG. 2a, the processing circuitry 111 of the AP 110 may, in response to receiving the second message 204 from the non-AP station 120, likewise derive a corresponding PTK, i.e. one or more cryptographic keys based on the Anonce and/or the Snonce, together with stored credential information and other parameters within the messages that are not shown. The processing circuitry 111 is further configured to encrypt information about one or more policies, in particular based on the one or more cryptographic key. The information about the one or more policies identifies one or more policies to be applied by the non-AP station 120.

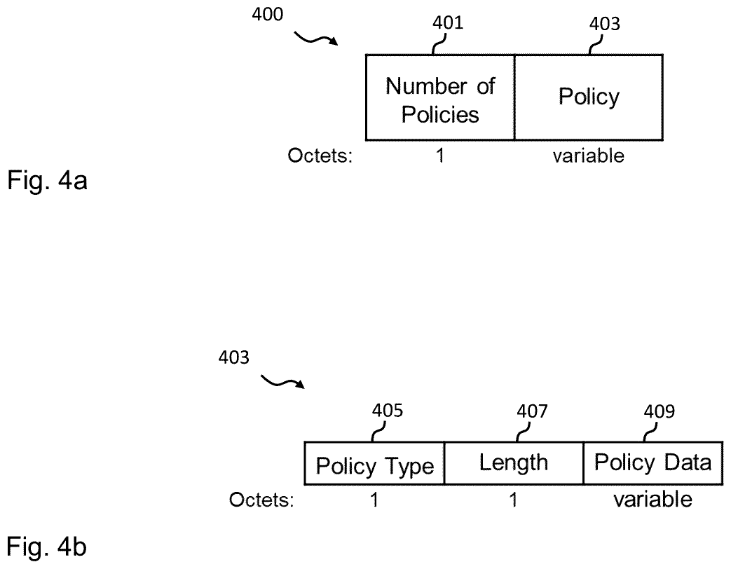

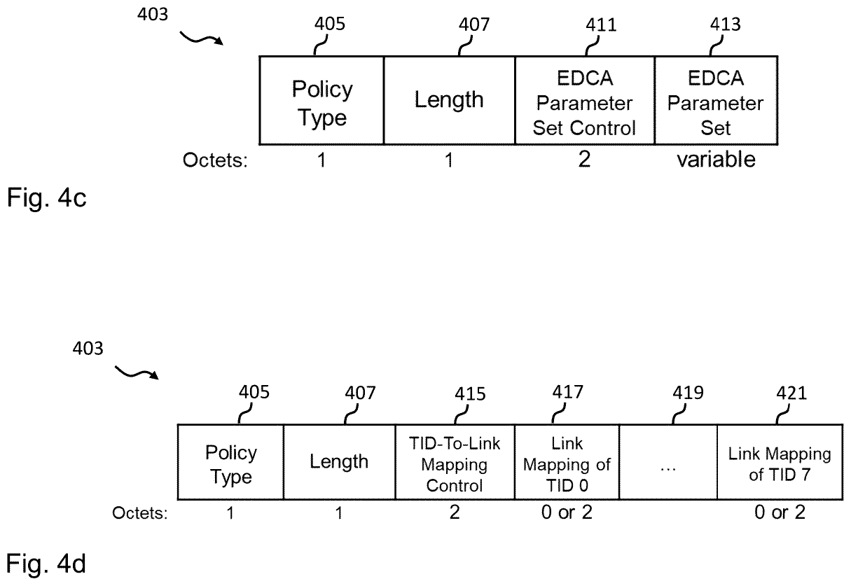

In step 209 of FIG. 2a, the communication interface 113 is further configured to transmit a third message 210 to the non-AP station 120. The third message 210 comprises the encrypted information about the one or more policies. As further described below, the information about the one or more policies may be comprised in a Policy Key Data Encapsulation, KDE, 400. The communication interface 113 may be configured to receive the information about the one or more policies from the policy server 150. The third message 210 may be a third EAPOL key message of a 4-way handshake between the AP 110 and the non-AP station 120. The third message 210 comprising the encrypted information about the one or more policies may comprise an indicator (e.g., Policy Type 405, of the number 401 (illustrated in FIG. 4a) of the one or more policies. The third message 210 may further comprise an indicator of a respective type 405 of the one or more policies and/or information about a respective size 407 of the one or more policies. Moreover, the AP 110 may transmit a capability bit signaling whether the AP 110 and/or further APs 110′ in the WLAN 130 support the one or more policies.

In step 211 of FIG. 2a, in response to transmitting the third EAPOL key message to the non-AP station 120, the communication interface 113 may be further configured to receive a fourth EAPOL key message from the non-AP station 120.

FIG. 2b shows a flow diagram illustrating steps implemented by the processing circuitry 111 of the AP 110 according to an embodiment using a request/response based 4-way handshake for an RSNA. In the following, only steps differing from the embodiment of FIG. 2a specified above will be described.

In step 205 of FIG. 2b, the non-AP station 120 may derive a PTK based on the nonce, together with stored credential information and other parameters within the messages, in response to receiving the first message 202. The non-AP station 120 may be further configured to encrypt a request for information about one or more policies.

In step 203 of FIG. 2b, the second EAPOL key message received to the AP 110 may further comprise the request for the information about the one or more policies by the non-AP station 120.

In step 207 of FIG. 2b, the processing circuitry 111 may be further configured to encrypt a response of the requested information about the one or more policies, in particular based on the one or more cryptographic key.

In step 209 of FIG. 2b, the third EAPOL key message transmitted from the AP 110 may further comprise the response of the requested information about the one or more policies.

FIG. 3a shows a flow diagram illustrating steps implemented by the processing circuitry 111 of the AP 110 according to an embodiment using fast initial link setup (FILS). As already described above, the communication interface 113 is configured to transmit a first message 202 and a third message 210 to the non-AP station 120. Moreover, the communication interface 113 is configured to receive a second message 204 from the non-AP station 120. In the following, only steps differing from the embodiment of FIG. 2a specified above will be described.

As illustrated in step 301, prior to transmitting the first message 202, the communication interface 113 may be configured to receive an 802.11 authentication request from the non-AP station 120. The 802.11 authentication request may comprise the supplicant nonce SNonce. The 802.11 authentication request from the non-AP station 120 may further comprise a request for the information about the one or more policies by the non-AP station 120.

As further illustrated in steps 303 to 307 of FIG. 3a, the first message 202 may be an 802.11 authentication response, the second message 204 may be an association request and the third message 210 may be an association response of a FILS between the AP 110 and the non-AP station 120. Thus, the information about the one or more policies, in particular the Policy KDE 400, can be communicated between the AP 110 and the non-AP station 120 by a FILS (Re) Association Request/Response. Moreover, the AP 110 may transmit a capability bit signaling whether the AP 110 and/or further APs 110′ in the WLAN 130 support the one or more policies.

In step 307 of FIG. 3a, the information about the one or more policies, in particular the Policy KDE 400, may be piggy backed, i.e. transported within the FILS exchange (Re) Association Response frame. In this case, a Key Delivery element may carry the key information as shown by Policy KDE 400.

FIG. 3b shows a flow diagram illustrating steps implemented by the processing circuitry 111 of the AP 110 according to an embodiment using a request/response based fast transition. In the following, only steps differing from the embodiment of FIG. 3a specified above will be described.

As further illustrated in steps 303 to 307 of FIG. 3b, the first message 202 may be an 802.11 authentication response, the second message 204 may be an association request and the third message 210 may be an association response of a fast transition (FT), using a specific Fast (BSS) Transition Authentication Algorithm (FTAA), between the AP 110 and the non-AP station 120. Thus, the information about the one or more policies, in particular the Policy KDE 400, can be communicated between the AP 110 and the non-AP station 120 by an FT (Re) Association Request/Response. The Policy KDE 400 may be piggy backed, i.e. transported within the FT exchange (Re) Association Response frame. A Mobility Domain Element (MDE) may carry the key information including the Policy KDE 400. In other words, the association response may comprise the MDE and the encrypted information about the one or more policies may be part of the MDE.

FIG. 3c shows a flow diagram illustrating steps implemented by the processing circuitry 111 of the AP 100 according to an embodiment using FILS. In the following, only steps differing from the embodiment of FIG. 3a specified above will be described.

In step 205 of FIG. 3c, the non-AP station 120 may derive a PTK based on the Anonce and/or the Snonce, together with other parameters within the messages, in response to receiving the first message 202. The non-AP station 120 may be further configured to encrypt a request for information about one or more policies.

In step 305 of FIG. 3c, the second message 204 received to the AP 110 may further comprise the request for the information about the one or more policies by the non-AP station 120.

In step 207 of FIG. 3c, the processing circuitry 111 may be further configured to encrypt a response of the requested information about the one or more policies, in particular based on the one or more cryptographic key.

In step 307 of FIG. 3c, the third message 210 transmitted from the AP 110 may further comprise the response of the requested information about the one or more policies. Moreover, the AP 110 may transmit a capability bit signaling whether the AP 110 and/or further APs 110′ in the WLAN 130 support the one or more policies.

FIG. 3d shows a flow diagram illustrating steps implemented by the processing circuitry 111 of the AP 110 according to an embodiment using a request/response based fast initial link setup. In the following, only steps differing from the embodiment of FIG. 3b specified above will be described.

In step 205 of FIG. 3d, the non-AP station 120 may derive a PTK based on the Anonce and/or the Snonce, together with stored credential information and other parameters within the messages, in response to receiving the first message 202. The non-AP station 120 may be further configured to encrypt a request for information about one or more policies.

In step 305 of FIG. 3d, the second message 204 received to the AP 110 may further comprise the request for the information about the one or more policies by the non-AP station 120.

In step 207 of FIG. 3d, the processing circuitry 111 may be further configured to encrypt a response of the requested information about the one or more policies, in particular based on the one or more cryptographic key.

In step 307 of FIG. 3d, the third message 210 transmitted from the AP 110 may further comprise the response of the requested information about the one or more policies. Moreover, the AP 110 may transmit a capability bit signaling whether the AP 110 and/or further APs 110′ in the WLAN 130 support the one or more policies.

FIGS. 4a-d show data structures of the Policy KDE 400. The Policy KDE 400 may comprise the information of the policy of the second message 204 and/or of the third message 210 of the 4-way handshake or the association request/response messages described above in FIGS. 2a to 3d. The Policy KDE 400 can be communicated in a secure manner prior to the non-AP station 120 establishing network access. The Policy KDE 400 allows an AP 110 to securely provide a set of policies to a non-AP station 120 during the Association/4-way handshake exchanges.

A new KDE selector may be generated according to Table 12-10 of IEEE 802.11 REVme D1.0 to indicate that this KDE is a “Policy KDE”. The OUI associated with this entry may for example be “00-OF-AC”.

As illustrated in FIG. 4a, the data field of the Policy KDE 400 may comprise the information about the number 401 of policies in a single octet, i.e. Byte and a policy field 403 in variable octets.

As further illustrated in FIG. 4b, the policy field 403 may comprise an indicator of the policy type 405, an indicator of the policy data 409, i.e. the information about the one or more policies in variable octets, and an indicator of the size 407, i.e. length 407 of the information about the one or more policies in a single octet.

TABLE 1
Policy Type definitions

| Policy Type | Type | Description |
|---|---|---|
| 0 | Reserved | |
| 1 | Non-AP MLD TID-to-link | Uplink TID-to-link |
| | mapping policy | mapping for the non-AP |
| | | MLD. |
| 2 | AP MLD (BSS) TID-to- | Downlink (unicast) TID- |
| | link mapping policy | to-link mapping for the |
| | | non-AP MLD |
| 3 | EDCA Parameter Set | Uplink EDCA Parameters |
| | uplink policy | |
| 4 | Security association | Communication of policy |
| | identifier or policy | or identifier to assist with |
| | | security association |
| 5 | Sensing policy | The sensing policy for a |
| | | SENS STA |
| | | (authorization, filtering, |
| | | thresholds, privacy settings) |
| 6 | Ranging policy | The ranging policy for a |
| | | SENS STA |
| | | (authorization, |
| | | thresholds, frame rate) |
| 7-125 | Reserved | |
| 126 | Tear Down | Remove the previous |
| | | policy settings |
| 127 | Wild card | Retrieves any available |
| | | policy |
| 128-255 | STA to AP requests | |

As exemplary shown in table 1, various policy types 405 can be defined.

If the policy type 405 is exemplary set to 1 or 2, an uplink TID-to-link mapping for the non-AP MLD or a downlink (unicast) TID-to-link mapping for the non-AP MLD may be defined.

If the policy type 405 is exemplary set to 3, an uplink of EDCA Parameters may be defined.

If the policy type 405 is exemplary set to 4, a security association identifier or policy, used to assist a security association between the non-AP station 120 and the AP 110 may be defined.

If the policy type 405 is exemplary set to 5, a sensing STA such as for example the non-AP station 120 that requires policy for setting sensing thresholds, filters and privacy values may be defined.

If the policy type 405 is exemplary set to 6, a sensing STA such as for example the non-AP station 120 that requires policy for setting ranging thresholds, frame rates and privacy values may be defined.

If the policy type 405 is exemplary set to 127, all available policies on the AP can be returned in the response message.

If the policy type 405 is exemplary set to 126, a Tear Down policy type is used, for example when the AP 110 wishes to remove any of the applied policies at the non-AP station 120. If a policy needs to be changed or removed, the AP 110 may communicate the policy by either triggering a 4-way handshake by sending EAPOL-key message as illustrated in FIGS. 2a-b or by including the Policy KDE 400 in a protected management frame as illustrated in FIG. 3b or 3d.

If the policy type 405 is exemplary set to 128-255, the policy type 405 may for example only be used for non-AP station 120 to AP 110 requests as described above for FIGS. 2b, 3b and 3d. In this case the policy type 405 has bit7 (+128) set to indicate the direction of the message.

FIG. 4c illustrates the policy data field encoding for the EDCA Parameter Set. In this case, the policy type 405 may be set to 3 as indicated in table 1. The definition of the EDCA Parameter Set Control 411 and data fields 413 may be set as defined in 9.4.2.28 of IEEE 802.11 REVme D1.0. For a MLD, the policy may define a link specific EDCA parameter set 413, i.e. the EDCA parameter set 413 is different per link or maybe even applied to only one link.

FIG. 4d illustrates the Policy Data field encoding for the TID to Link Mapping. In this case, the policy type 405 may be set to either 1 or 2 depending on the uplink or downlink direction according to table 1. The TID-To-Link Mapping Control 415 may be set as defined in clause 9.4.2.295d of the IEEE 802.11be D1.4 and the Link Mapping 417, 419, 421 of TID i, in the current example for 0≤i≤7, may be set as defined in 9.4.2.295d.

Advantageously, the specific STA policy information during the 4-way handshake exchanges optimizes the connection process. In addition to the policies already described above, there are other IEEE 802.11 policies that could take advantage of this mechanism. The specific STA policy information may also be requested by the non-AP station 120 by sending a request to the AP 110 that is forwarded to the policy server 150 in the WLAN 130 and/or SSPN 140.

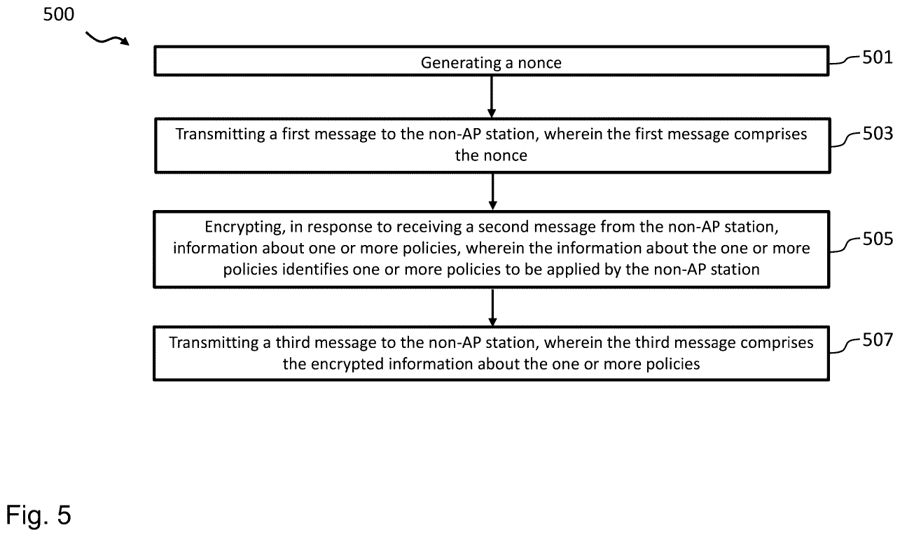

FIG. 5 shows a flow diagram illustrating steps of a method 500 of operating the AP 110 according to an embodiment in a WLAN 130.

The method 500 comprises a step 501 of generating the authenticator nonce ANonce.

The method 500 further comprises a step 503 of transmitting the first message 202 to the non-AP station 120, wherein the first message 202 comprises the nonce, and other parameters that are not shown.

The method 500 further comprises a step 505 of encrypting, in response to receiving the second message 204 from the non-AP station 120, information about one or more policies, wherein the information about the one or more policies identifies one or more policies to be applied by the non-AP station 120.

The method 500 further comprises a step 507 of transmitting the third message 210 to the non-AP station 120, wherein the third message 210 comprises the encrypted information about the one or more policies.

As the method 500 can be implemented by the AP 110, further features of the method 500 result directly from the functionality of the AP 110 and its different embodiments described above and below.

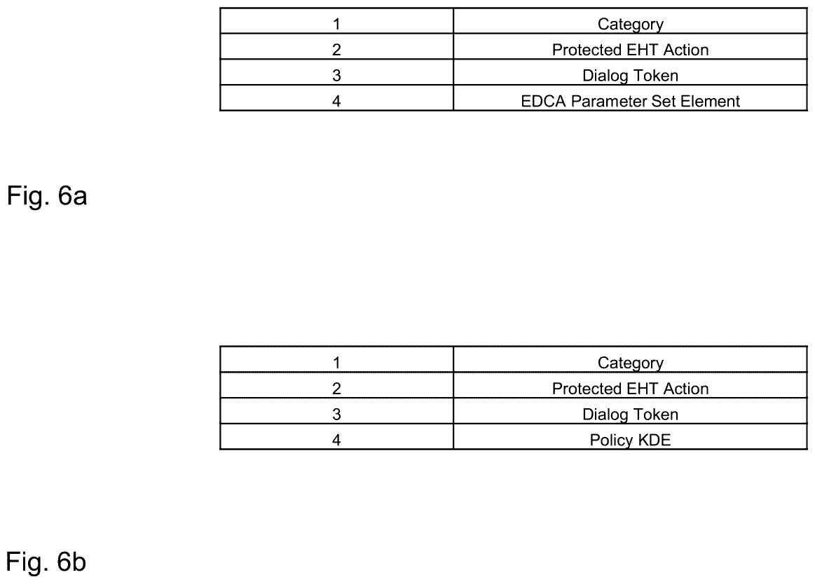

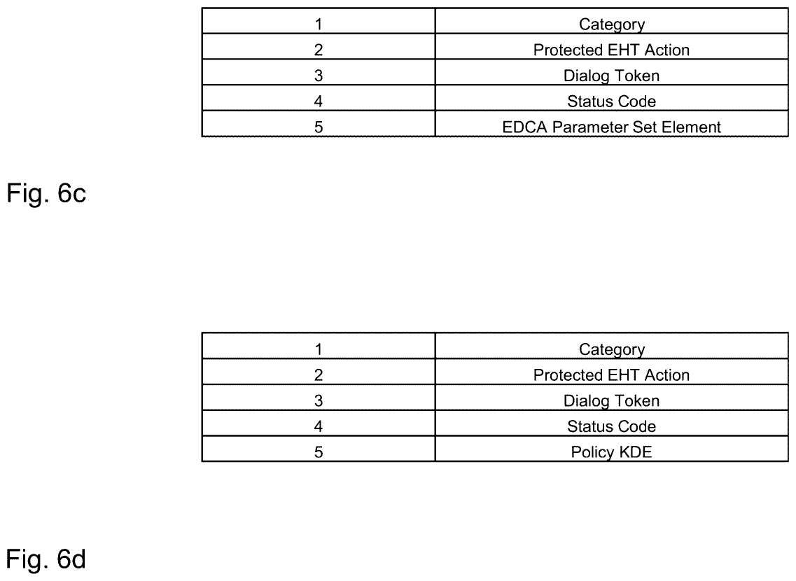

FIGS. 6a-b show data structures illustrating respectively the state of the art EPCS Priority Access Enable Request frame (IEEE 802.11 Draft 1.4) and the modified EPCS Priority Access Enable Request frame of the present invention.

An alternative is to re-define the existing EPCS Priority Access Enable Request (defined in Table 9-623h IEEE 802.11 Draft 1.4) in such a way to allow it to carry the Policy KDE, as opposed to an EDCA Parameter Set. The benefit of this is to enable the EPCS Priority Access Enable messages to be used for other policies in addition to the EDCA Parameter Set.

FIGS. 6c-d show data structures illustrating respectively the state of the art EPCS Priority Access Enable Response frame (IEEE 802.11 Draft 1.4) and the modified EPCS Priority Access Enable Response frame of the present invention.

A similar redefinition can be used to adapt the existing EPCS Priority Access Enable Response (defined in Table 9-623i IEEE 802.11 Draft 1.4) to allow it to carry the Policy KDE, as opposed to an EDCA Parameter Set. The benefit of this is to enable the EPCS Priority Access Enable messages to be used for other policies in addition to the EDCA Parameter Set.

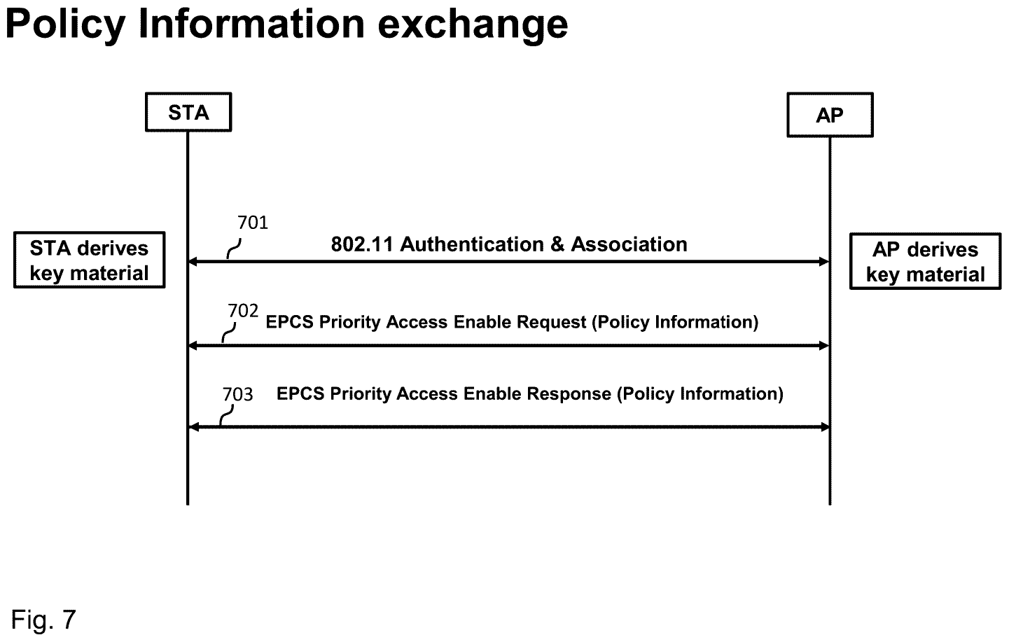

FIG. 7 shows a flow diagram illustrating steps implemented by the processing circuitry 111 of the AP 110 according to an embodiment for policy information exchange.

In step 701 of FIG. 7, an access point, AP, and a non-AP station in a wireless local area network, WLAN, exchange authentication messages, and each derives a key from the authentication messages. A person skilled in the art will readily understand that this process can be triggered by any of the access point, AP, and the non-AP station.

In step 702 of FIG. 7, the AP transmits to the non-AP station a policy information request. Alternatively, the non-AP station may be the one to transmit a policy information request.

In step 703 of FIG. 7, the non-AP station transmits to the AP a policy information response. If in step 702 the non-AP station has been the one to transmit a policy information request, a person skilled in the art would readily understand that step 703 comprises the AP transmitting a policy information response.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the invention may be integrated into one processing unit, or each of the units may exist alone physically, or two or more units are integrated into one unit.

1. An access point (AP) (110) configured to communicate with a non-AP station (120) in a wireless local area network (WLAN) (130), wherein the AP (110) comprises:
a processor (111) configured to generate a nonce; and
a communication interface (113) configured to transmit a first message (202) to the non-AP station (120), wherein the first message (202) comprises the nonce;
wherein, in response to receiving a second message (204) from the non-AP station (120), the processor (111) is further configured to encrypt information about one or more policies, wherein the information about the one or more policies identifies one or more policies to be applied by the non-AP station (120);
wherein the communication interface (113) is further configured to transmit a third message (210) to the non-AP station (120), wherein the third message (210) comprises the encrypted information about the one or more policies.

2. The AP (110) of claim 1, wherein the first message (202) is a first Extensible Authentication Protocol over Local Area Network (EAPOL) key message, the second message (204) is a second EAPOL key message and the third message (210) is a third EAPOL key message of a 4-way handshake between the AP (110) and the non-AP station (120), wherein the second EAPOL key message comprises a further nonce.

3. The AP (110) of claim 2, wherein, in response to transmitting the third EAPOL key message to the non-AP station (120), the communication interface (113) is further configured to receive a fourth EAPOL key message from the non-AP station (120).

4. The AP (110) of claim 2, wherein the processor (111) is configured to derive one or more cryptographic keys based on at least one of the nonce or the further nonce.

5. The AP (110) of claim 2, wherein the second EAPOL key message comprises a request for the information about the one or more policies by the non-AP station (120).

6. The AP (110) of claim 1, wherein the first message (202) is an 802.11 authentication response, the second message (204) is an association request, and the third message (210) is an association response of a fast transition or a fast initial link setup between the AP (110) and the non-AP station (120).

7. The AP (110) of claim 6, wherein the communication interface (113) is configured to transmit the 802.11 authentication response to the non-AP station (120), in response to receiving an 802.11 authentication request from the non-AP station (120), wherein the 802.11 authentication request comprises a further nonce.

8. The AP (110) of claim 7, wherein the processor (111) is configured to derive one or more cryptographic keys based on at least one of the nonce or the further nonce.

9. The AP (110) of claim 6, wherein the association response comprises a mobility domain element (MDE) and wherein the encrypted information about the one or more policies is part of the MDE.

10. The AP (110) of claim 6, wherein the 802.11 authentication request from the non-AP station (120) comprises a request for the information about the one or more policies by the non-AP station (120).

11. The AP (110) of claim 1, wherein third message (210) comprising the encrypted information about the one or more policies comprises information about a number (401) of the one or more policies.

12. The AP (110) of claim 1, wherein the third message (210) comprising the encrypted information about the one or more policies comprises at least one of an indicator of a respective type (405) of the one or more policies or information about a respective size (407) of the one or more policies.

13. The AP (110) of claim 1, wherein the communication interface (113) is configured to receive the information about the one or more policies from a policy server (150).

14. A method (500) of operating an access point (AP) (110) configured to communicate with a non-AP station (120) in a wireless local area network (WLAN) (130), wherein the method (500) comprises:
generating (501) a nonce;
transmitting (503) a first message (202) to the non-AP station (120), wherein the first message (202) comprises the nonce;
encrypting (505), in response to receiving a second message (204) from the non-AP station (120), information about one or more policies, wherein the information about the one or more policies identifies one or more policies to be applied by the non-AP station (120);
transmitting (507) a third message (210) to the non-AP station (120), wherein the third message (210) comprises the encrypted information about the one or more policies.

15. The method (500) of claim 14, wherein the first message (202) is a first Extensible Authentication Protocol over Local Area Network (EAPOL) key message, the second message (204) is a second EAPOL key message and the third message (210) is a third EAPOL key message of a 4-way handshake between the AP (110) and the non-AP station (120), wherein the second EAPOL key message comprises a further nonce.

16. The method (500) of claim 15, wherein, in response to transmitting the third EAPOL key message to the non-AP station (120), the method (500) further comprises:
receiving a fourth EAPOL key message from the non-AP station (120).

17. The method (500) of claim 15, wherein the method (500) further comprises:
deriving one or more cryptographic keys based on at least one of the nonce or the further nonce.

18. A chip, applied to an access point (AP) (100) configured to communicate with a non-AP station (120) in a wireless local area network (WLAN) (130), comprising:
generating (501) a nonce;
transmitting (503) a first message (202) to the non-AP station (120), wherein the first message (202) comprises the nonce;
encrypting (505), in response to receiving a second message (204) from the non-AP station (120), information about one or more policies, wherein the information about the one or more policies identifies one or more policies to be applied by the non-AP station (120);
transmitting (507) a third message (210) to the non-AP station (120), wherein the third message (210) comprises the encrypted information about the one or more policies.

19. The chip of claim 18, wherein the first message (202) is a first Extensible Authentication Protocol over Local Area Network (EAPOL) key message, the second message (204) is a second EAPOL key message and the third message (210) is a third EAPOL key message of a 4-way handshake between the AP (110) and the non-AP station (120), wherein the second EAPOL key message comprises a further nonce.

20. The chip of claim 19, wherein, in response to transmitting the third EAPOL key message to the non-AP station (120), the chip further comprises: receiving a fourth EAPOL key message from the non-AP station (120).
